(19) United States
(12) Patent Application Publication
(10) Pub. No.: US 2026/0066427 A1
(43) Pub. Date: Mar. 5, 2026

(54) BATTERY PACK

(71) Applicant: TOYOTA JIDOSHA KABUSHIKI KAISHA, Toyota-shi (JP)

(72) Inventors: Masataka OGUSHI, Nisshin-shi (JP); Hiroaki SUEYOSHI, Okazaki-shi (JP); Masato MORITAKA, Chiryu-shi (JP)

(73) Assignee: TOYOTA JIDOSHA KABUSHIKI KAISHA, Toyota-shi (JP)

(21) Appl. No.: 19/245,809

(22) Filed: Jun. 23, 2025

(30) Foreign Application Priority Data
Sep. 5, 2024 (JP) 2024-153468

(51) Int. Cl. H01M 50/242; H01M 50/249; H01M 50/264

(52) U.S. Cl. CPC H01M 50/242; H01M 50/249; H01M 50/264

(57) ABSTRACT

A battery pack includes a battery module, a lower case to which the battery module is fixed, an upper frame disposed on the vehicle upper side with respect to the lower case, and a support member disposed on both sides, in the vehicle width direction, with respect to the battery module. The support member is fixed to the lower case and the upper case in the state of extending in the up-down direction between the lower case and the upper frame, the support member supporting the upper frame from the lower side. A first deformation starting point portion is provided on the side of a portion of the support member that is fixed to the lower case, the first deformation starting point portion serving as a deformation starting point at which deformation starts when the support member falls toward one side in the vehicle width direction.

### CROSS-REFERENCE TO RELATED APPLICATION

This application claims priority to Japanese Patent Application No. 2024-153468 filed on Sep. 5, 2024. The disclosure of the above-identified application, including the specification, drawings, and claims, is incorporated by reference herein in its entirety.

### BACKGROUND

### 1. Technical Field

The present disclosure relates to a battery pack.

### 2. Description of Related Art

Japanese Unexamined Patent Application Publication No. 2013-134809 (JP 2013-134809 A) discloses a battery pack to be installed in a vehicle, a home, etc. The battery pack includes a plurality of battery modules. A frame having an outer peripheral frame portion that surrounds the outer periphery of the battery modules is mounted to the battery modules. The frame includes a fixation portion to be fixed to the battery modules, a fixation portion that receives another frame, and a fixation portion to be fixed to another member. The frame enables the battery modules to be stacked. The outer peripheral frame portion of the frame has high rigidity to resist deformation of the battery modules. This makes it possible to implement a structure in which the battery modules are stacked while suppressing deformation of the battery modules.

### SUMMARY

When the battery pack is mounted on a vehicle, it may be desirable to reduce the amount of displacement of the battery pack toward the vehicle upper side in the event of a side collision of the vehicle, depending on the positional relationship between the battery pack and devices around the battery pack.

In consideration of the above, an object of the present disclosure is to provide a battery pack that is less likely to be displaced toward the vehicle upper side in the event of a side collision of a vehicle.

A first aspect provides a battery pack including: a battery module configured to include a plurality of battery cells; a lower floor member to which the battery module is fixed; an upper floor member disposed on a vehicle upper side with respect to the lower floor member; a support member disposed on both sides, in a vehicle width direction, with respect to the battery module and fixed to the lower floor member and the upper floor member in a state of extending, in a vehicle up-down direction, between the lower floor member and the upper floor member, the support member supporting the upper floor member from a lower side; and a first deformation starting point portion provided on a side of a portion of the support member that is fixed to the lower floor member, the first deformation starting point portion serving as a deformation starting point at which deformation starts when the support member falls toward one side in the vehicle width direction.

In the battery pack according to the first aspect, the battery module is fixed to the lower floor member. The upper floor member is provided on the vehicle upper side of the battery module fixed to the lower floor member. Furthermore, the support member extending between the lower floor member and the upper floor member is provided on both sides, in the vehicle width direction, of the battery module fixed to the lower floor member. Here, when a load toward one side in the vehicle width direction is input to the upper floor member in the event of a side collision of the vehicle, the upper floor member is displaced toward one side in the vehicle width direction, and the first deformation starting point portion provided on the side of the portion of the support member that is fixed to the lower floor member is deformed, causing the support member to fall toward one side in the vehicle width direction. This suppresses separation or breakage at the portion of the support member that is fixed to the lower floor member, suppressing displacement of the upper floor member toward the vehicle upper side. That is, it is possible to suppress displacement of the battery pack toward the vehicle upper side.

A second aspect provides the battery pack according to the first aspect, in which: a load receiving portion is provided on an outer side, in the vehicle width direction, with respect to the upper floor member, the load receiving portion being contacted by the upper floor member displaced toward the one side in the vehicle width direction; and a second deformation starting point portion is provided at an intermediate portion, in the vehicle up-down direction, of the support member between the first deformation starting point portion and the upper floor member, the second deformation starting point portion serving as a deformation starting point at which deformation starts when the support member falls toward another side in the vehicle width direction after contacting the load receiving portion.

In the battery pack according to the second aspect, when a load toward one side in the vehicle width direction is input to displace the upper floor member toward one side in the vehicle width direction, the upper floor member comes into contact with the load receiving portion to deform the second deformation starting point portion of the support member. In this manner, by deforming the support member with the second deformation starting point portion serving as the deformation starting point in addition to the first deformation starting point portion, it is possible to further suppress displacement of the upper floor member toward the vehicle upper side. That is, it is possible to further suppress displacement of the battery pack toward the vehicle upper side.

A third aspect provides the battery pack according to the second aspect, in which: the battery modules are coupled in the vehicle up-down direction in a state of being stacked in the vehicle up-down direction; and a position, in the vehicle up-down direction, of the second deformation starting point portion is set to the same position as a position, in the vehicle up-down direction, of a coupling portion between one of the battery modules and a different one of the battery modules.

In the battery pack according to the third aspect, the position, in the vehicle up-down direction, of the second deformation starting point portion of the support member is set to the same position as the position, in the vehicle up-down direction, of the coupling portion between one of the battery modules and a different one of the battery modules. With this configuration, when the second deformation starting point portion is deformed, it is possible to suppress the second deformation starting point portion, deformed toward the battery module side, contacting the one battery module and the different battery module.

A fourth aspect provides the battery pack according to the second or third aspect, in which a third deformation starting point portion is provided on a side of a portion of the support member that is fixed to the upper floor member, the third deformation starting point portion serving as a deformation starting point at which deformation starts after the upper floor member contacts the load receiving portion.

In the battery pack according to the fourth aspect, when a load toward one side in the vehicle width direction is input to displace the upper floor member toward one side in the vehicle width direction, the upper floor member comes into contact with the load receiving portion to deform the third deformation starting point portion of the support member. In this manner, by deforming the support member with the third deformation starting point portion serving as the deformation starting point in addition to the first deformation starting point portion and the second deformation starting point portion, it is possible to further suppress displacement of the upper floor member toward the vehicle upper side. That is, it is possible to further suppress displacement of the battery pack toward the vehicle upper side.

A fifth aspect provides the battery pack according to any one of the first to fourth aspects, in which: the battery cells are all-solid-state batteries and are disposed in a state of being arranged in a vehicle front-rear direction; an end plate is fixed to an end portion, on a vehicle front side, and an end portion, on a vehicle rear side, of the battery module; and the end plate is fixed to each of the lower floor member and the upper floor member.

In the battery pack according to the fifth aspect, the end plate is fixed to each of the end portion, on the vehicle front side, and the end portion, on the vehicle rear side, of the battery module. In addition, the end plate is fixed to each of the lower floor member and the upper floor member. With this configuration, in which the upper floor member is fixed to the end plate of the battery module and the lower floor member, it is possible to further suppress upward displacement of the upper floor member. In particular, the all-solid-state batteries have a highly rigid structure to withstand the application of a high restraining pressure, and therefore it is possible to further suppress displacement of the upper floor member toward the vehicle upper side. That is, it is possible to further suppress displacement of the battery pack toward the vehicle upper side.

The battery pack according to the present disclosure has the excellent effect of being less likely to be displaced toward the vehicle upper side in the event of a side collision of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a battery pack with an upper cover removed;

FIG. 2 is a cross-sectional view illustrating a cross section of the battery pack taken along the vehicle width direction and the up-down direction;

FIG. 3 is a cross-sectional view corresponding to FIG. 2, schematically illustrating a state in which a collision load due to a side collision is input; and

FIG. 4 is a cross-sectional view corresponding to FIG. 3, illustrating a state in which first deformation starting point portions, second deformation starting point portions, and third deformation starting point portions are deformed.

### DETAILED DESCRIPTION OF EMBODIMENTS

A battery pack 10 according to an embodiment of the present disclosure will be described below with reference to the drawings. Of the arrows indicated as appropriate in the drawings, the arrow FR indicates the vehicle front side, the arrow UP indicates the vehicle upper side, the arrow LH indicates the left side in the vehicle width direction (right-left direction), and the arrow RH indicates the right side in the vehicle width direction (right-left direction). In the following description, when front/rear, up/down, and right/left directions are indicated, such directions refer to the front/rear directions in the vehicle front-rear direction, the up/down directions in the vehicle up-down direction, and the right/left directions in the vehicle right-left direction unless otherwise specified.

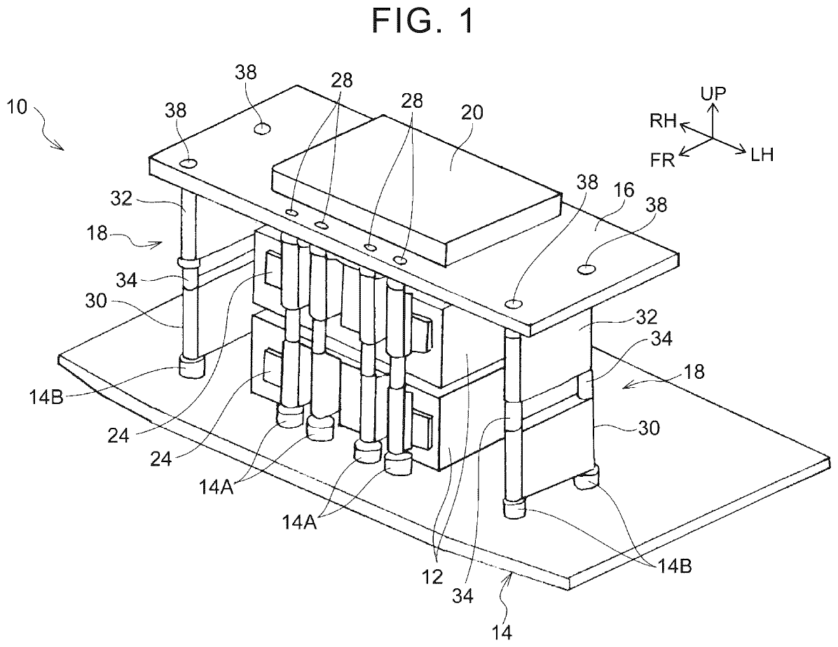

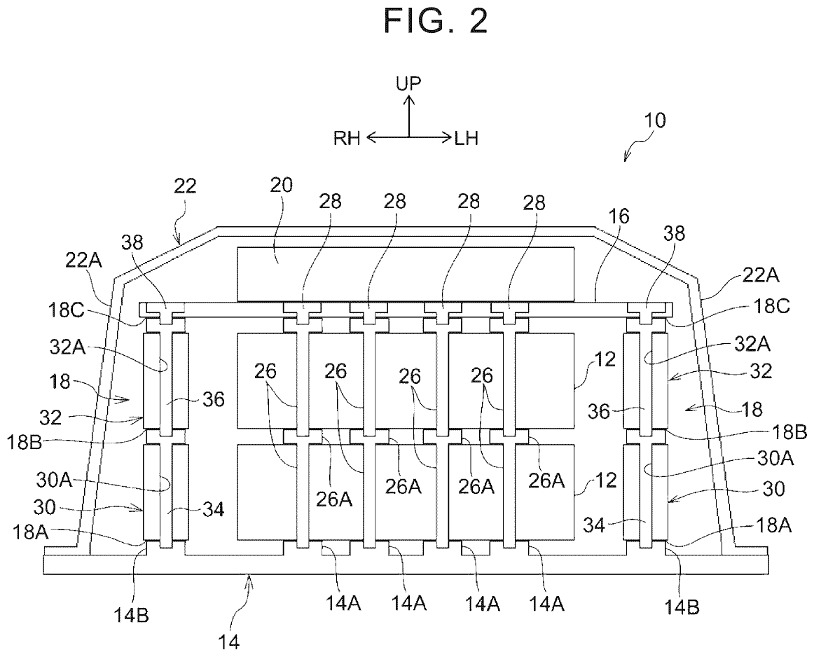

As illustrated in FIGS. 1 and 2, a battery pack 10 includes: a battery module 12 configured to include a plurality of battery cells; a lower case 14 serving as a lower floor member to which the battery module 12 is fixed; and an upper frame 16 serving as an upper floor member disposed above the lower case 14. The battery pack 10 also includes: a pair of right and left support members 18 that supports the upper frame 16 from the lower side; a device 20 fixed to the upper frame 16; and an upper cover 22 that covers the battery module 12, the device 20, etc., from the upper side.

The battery module 12 is configured such that a plurality of battery cells as all-solid-state batteries are arranged in the front-rear direction, and has an overall shape of a rectangular parallelepiped. An end plate 24 is fixed to each of the front end portion and the rear end portion of the battery module 12. The end plate 24 is fixed to each of the lower case 14 and the upper frame 16, as described later. In FIG. 2, the end plate 24 is not illustrated. In the present embodiment, two battery modules 12 are coupled in the up-down direction in the state of being stacked in the up-down direction. In the following description, the lower battery module 12 is occasionally referred to as a first-tier battery module 12, and the upper battery module 12 is occasionally referred to as a second-tier battery module 12.

The lower case 14 is formed in the shape of a rectangular plate that extends in the front-rear direction and the right-left direction and that has a thickness direction in the up-down direction. A plurality of battery fixing bolt screwing portions 14A is provided at the center portion, in the right-left direction, of the lower case 14. Battery fixing bolts 26 are screwed into the battery fixing bolt screwing portions 14A. In the present embodiment, four battery fixing bolt screwing portions 14A are provided at the center portion, in the right-left direction, of the front portion of the lower case 14, and four battery fixing bolt screwing portions 14A are provided at the center portion, in the right-left direction, of the rear portion of the lower case 14.

Four battery fixing bolts 26 are inserted into the end plate 24 fixed to the front end portion of the first-tier battery module 12. These four battery fixing bolts 26 are respectively screwed into the four battery fixing bolt screwing portions 14A provided at the center portion, in the right-left direction, of the front portion of the lower case 14. Similarly, four battery fixing bolts 26 are inserted into the end plate 24 fixed to the rear end portion of the first-tier battery module 12. These four battery fixing bolts 26 are respectively screwed into the four battery fixing bolt screwing portions 14A provided at the center portion, in the right-left direction, of the rear portion of the lower case 14. This allows the first-tier battery module 12 to be fixed to the lower case 14.

In addition, four battery fixing bolts 26 are inserted into the end plate 24 fixed to the front end portion of the second-tier battery module 12. These four battery fixing bolts 26 are respectively screwed into the upper end portions of the four battery fixing bolts 26 on the first-tier battery module 12 side. Similarly, four battery fixing bolts 26 are inserted into the end plate 24 fixed to the rear end portion of the second-tier battery module 12. These four battery fixing bolts 26 are respectively screwed into the upper end portions of the four battery fixing bolts 26 on the first-tier battery module 12 side. This allows the second-tier battery module 12 to be fixed to the lower case 14.

Further, two first fixing bolt screwing portions 14B are provided at the left portion of the lower case 14. First fixing bolts 34 are screwed into the first fixing bolt screwing portions 14B, as described later. These two first fixing bolt screwing portions 14B are disposed at an interval in the front-rear direction. Further, two first fixing bolt screwing portions 14B are provided at the right portion of the lower case 14. First fixing bolts 34 are screwed into the first fixing bolt screwing portions 14B, as described later. These two first fixing bolt screwing portions 14B are disposed at an interval in the front-rear direction.

The upper frame 16 is formed in the shape of a rectangular plate that extends in the front-rear direction and the right-left direction and that has a thickness direction in the up-down direction. Four frame fixing bolts 28 are inserted into the front end portion of the upper frame 16. These four frame fixing bolts 28 are respectively screwed into the upper end portions of the four battery fixing bolts 26 on the second-tier battery module 12 side. Similarly, four frame fixing bolts 28 are inserted into the rear end portion of the upper frame 16. These four frame fixing bolts 28 are respectively screwed into the upper end portions of the four battery fixing bolts 26 on the second-tier battery module 12 side. This allows the upper frame 16 to be fixed to the upper part of the second-tier battery module 12. Furthermore, the device 20 is provided on the upper side of the upper frame 16. The device 20 is fixed to the upper part of the upper frame 16. The device 20 may be a device related to charging and discharging of the battery module 12, or may be a device having a different function.

The right and left support members 18 are disposed on both sides, in the vehicle width direction, with respect to the battery module 12, and fixed to the lower case 14 and the upper frame 16 in the state of extending in the up-down direction between the lower case 14 and the upper frame 16. The support members 18 are each configured to include a first bracket 30, a second bracket 32, first fixing bolts 34, second fixing bolts 36, and third fixing bolts 38.

The first bracket 30 is formed in the shape of a rectangular plate that extends in the front-rear direction and the up-down direction and that has a thickness direction in the right-left direction. A first fixing bolt insertion hole 30A, into which the first fixing bolt 34 is inserted, is formed at each of the front end portion and the rear end portion of the first bracket 30.

As with the first bracket 30, the second bracket 32 is formed in the shape of a rectangular plate that extends in the front-rear direction and the up-down direction and that has a thickness direction in the right-left direction. A second fixing bolt insertion hole 32A, into which the second fixing bolt 36 is inserted, is formed at each of the front end portion and the rear end portion of the second bracket 32.

In the left support member 18, the two first fixing bolts 34 inserted into the front and rear first fixing bolt insertion holes 30A of the first bracket 30 are screwed into the two first fixing bolt screwing portions 14B provided in the left portion of the lower case 14. In addition, the two second fixing bolts 36 inserted into the front and rear second fixing bolt insertion holes 32A of the second bracket 32 are screwed into the upper end portions of the two first fixing bolts 34. Furthermore, the two third fixing bolts 38 inserted into the left end portion of the upper frame 16 are screwed into the upper end portions of the two second fixing bolts 36.

In the right support member 18, the two first fixing bolts 34 inserted into the front and rear first fixing bolt insertion holes 30A of the first bracket 30 are screwed into the two first fixing bolt screwing portions 14B provided in the right portion of the lower case 14. In addition, the two second fixing bolts 36 inserted into the front and rear second fixing bolt insertion holes 32A of the second bracket 32 are screwed into the upper end portions of the two first fixing bolts 34. Furthermore, the two third fixing bolts 38 inserted into the right end portion of the upper frame 16 are screwed into the upper end portions of the two second fixing bolts 36.

Here, the portion of the first fixing bolt 34 that is screwed into the first fixing bolt screwing portion 14B serves as a first deformation starting point portion 18A that serves as a deformation starting point at which deformation starts when a load due to a side collision is input. In addition, the portion of the second fixing bolt 36 that is screwed into the first fixing bolt 34 serves as a second deformation starting point portion 18B that serves as a deformation starting point at which deformation starts when a load due to a side collision is input and the support member falls toward the other side in the vehicle width direction. The position, in the up-down direction, of the second deformation starting point portion 18B is the same as the position of screwing portions 26A of the upper and lower battery fixing bolts 26 as the coupling portions between the first-tier battery module 12 and the second-tier battery module 12. Furthermore, the portion of the third fixing bolt 38 that is screwed into the second fixing bolt 36 serves as a third deformation starting point portion 18C that serves as a deformation starting point at which deformation starts when a load due to a side collision is input.

As illustrated in FIG. 2, the upper cover 22 is formed to have a hat-shaped cross section with an open lower side when viewed in a cross section taken along the up-down direction and the right-left direction. The lower end portions of the upper cover 22 on both sides in the right-left direction are fixed to both end portions, in the right-left direction, of the lower case 14. This allows the battery modules 12, the upper frame 16, the device 20, and the right and left support members 18 to be covered by the upper cover 22 from the upper side and from the right and left directions. Here, the portions of the upper cover 22 that face the right and left end portions of the upper frame 16 in the right-left direction each form a load receiving portion 22A.

### Functions and Effects of the Present Embodiment

Next, the functions and the effects of the present embodiment will be described.

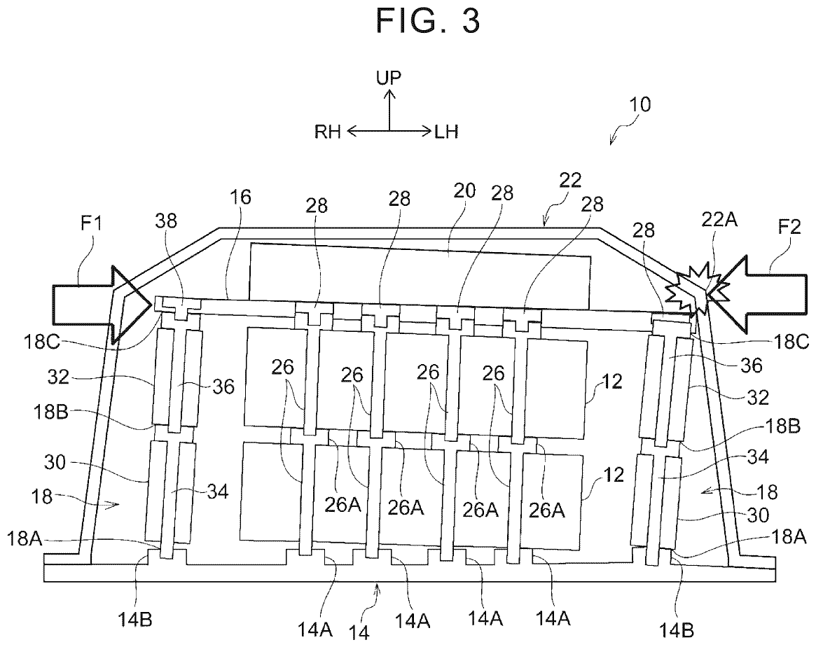

When a load F1 toward the left side is input to the upper frame 16 as illustrated in FIG. 3, for example, in the event of a side collision of a vehicle provided with the battery pack 10 according to the present embodiment described above, the upper frame 16 is displaced toward one side in the vehicle width direction while tilting the right and left support members 18 toward the left side. Then, the first deformation starting point portions 18A of the right and left support members 18 are plastically deformed, causing the support members 18 to fall toward the left side. This suppresses separation or breakage at the portion of the support members 18 that is fixed to the lower case 14, suppressing upward displacement of the upper frame 16. That is, it is possible to suppress upward displacement of the battery pack 10. Furthermore, by suppressing upward displacement of the upper frame 16, it is possible to suppress contact of the device 20 fixed to the upper part of the upper frame 16 with the upper cover 22.

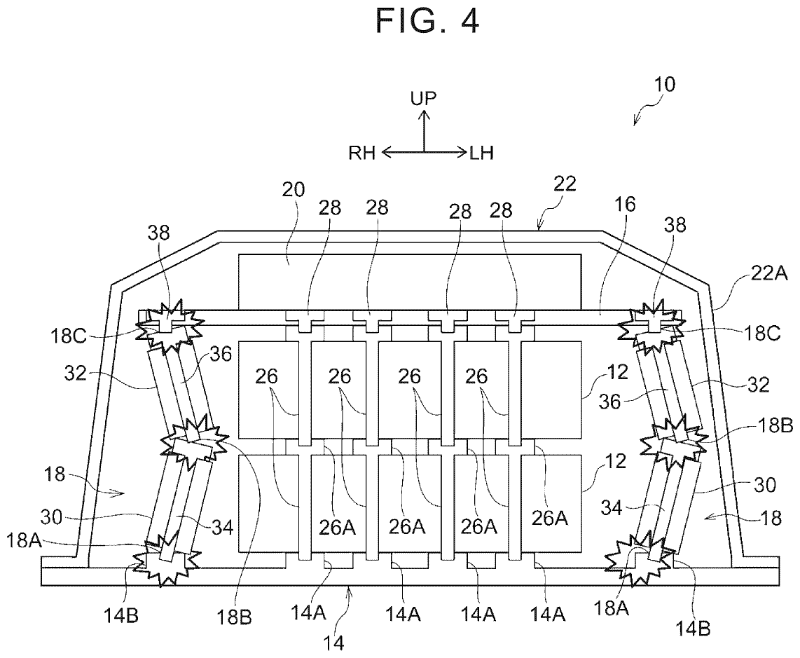

In addition, when the upper frame 16 is displaced toward the left side, the left end portion of the upper frame 16 comes into contact with the load receiving portion 22A of the upper cover 22, and a reaction load F2 is input from the load receiving portion 22A to the upper frame 16. As a result, the second deformation starting point portions 18B of the right and left support members 18 are plastically deformed, as illustrated in FIG. 4. In this manner, by deforming the support members 18 with the second deformation starting point portions 18B serving as deformation starting points in addition to the first deformation starting point portions 18A, it is possible to further suppress upward displacement of the upper frame 16. That is, it is possible to further suppress upward displacement of the battery pack 10. Here, in a state in which the second deformation starting point portions 18B are deformed, the second brackets 32 are displaced so as to tilt toward the right side with respect to the first brackets 30.

Here, the position, in the up-down direction, of the second deformation starting point portion 18B of the support member 18 in the state before the side collision (the state illustrated in FIG. 2) is set to the same position as the position, in the up-down direction, of the coupling portion between the first-tier battery module 12 and the second-tier battery module 12. With this configuration, it is possible to suppress the second deformation starting point portion 18B coming into contact with the side surfaces of the first-tier battery module 12 and the second-tier battery module 12 when the second deformation starting point portion 18B is deformed.

In addition, when the left end portion of the upper frame 16 comes into contact with the load receiving portion 22A of the upper cover 22 and a reaction load F2 is input from the load receiving portion 22A to the upper frame 16, the third deformation starting point portions 18C of the support members 18 are deformed. In this manner, by deforming the support members 18 with the third deformation starting point portions 18C serving as deformation starting points in addition to the first deformation starting point portions 18A and the second deformation starting point portions 18B, it is possible to further suppress upward displacement of the upper frame 16. That is, it is possible to further suppress upward displacement of the battery pack 10.

As illustrated in FIG. 1, in the battery pack 10 according to the present embodiment, the end plate 24 is fixed to each of the front end portion and the rear end portion of the battery module 12. Moreover, the end plate 24 is fixed to each of the lower case 14 and the upper frame 16. With this configuration, in which the upper frame 16 is fixed to the end plate 24 of the battery module 12 and the lower case 14, it is possible to further suppress upward displacement of the upper frame 16. In particular, the all-solid-state batteries have a highly rigid structure to withstand the application of a high restraining pressure, and therefore it is possible to further suppress upward displacement of the upper frame 16.

While the first deformation starting point portion 18A is the portion of the first fixing bolt 34 that is screwed into the first fixing bolt screwing portion 14B in the present embodiment, the present disclosure is not limited thereto. It is only necessary that the first deformation starting point portion 18A should be constituted as the starting point of deformation. For example, a structure with lower rigidity may be used, a groove or a hole may be provided, or a different material may be used. This can also be applied to the second deformation starting point portion 16B and the third deformation starting point portion 18C.

While the battery module 12 includes a plurality of battery cells as all-solid-state batteries in the present embodiment, the present disclosure is not limited thereto. For example, the battery module 12 may be configured to include a plurality of battery cells containing an electrolyte.

While the battery module 12 is fixed to the lower case 14 and the upper frame 16 via the end plate 24 in the present embodiment, the present disclosure is not limited thereto. For example, the battery module 12 may be fixed to the lower case 14 and the upper frame 16 by a fixing structure having a configuration different from that of the end plate 24.

While the support member 18 is deformed using not only the first deformation starting point portion 18A but also the second deformation starting point portion 18B and the third deformation starting point portion 18C as deformation starting points, the present disclosure is not limited thereto. It may be set, as appropriate, whether to provide the second deformation starting point portion 18B and the third deformation starting point portion 18C in consideration of the configuration around the battery pack 10, etc.

While one embodiment of the present disclosure has been described above, the present disclosure is not limited to the above, and it is of course possible to implement the present disclosure in various other modified forms without departing from the spirit and scope of the present disclosure.

What is claimed is:

1. A battery pack comprising:
a battery module configured to include a plurality of battery cells;
a lower floor member to which the battery module is fixed;
an upper floor member disposed on a vehicle upper side with respect to the lower floor member;
a support member disposed on both sides, in a vehicle width direction, with respect to the battery module and fixed to the lower floor member and the upper floor member in a state of extending, in a vehicle up-down direction, between the lower floor member and the upper floor member, the support member supporting the upper floor member from a lower side; and
a first deformation starting point portion provided on a side of a portion of the support member that is fixed to the lower floor member, the first deformation starting point portion serving as a deformation starting point at which deformation starts when the support member falls toward one side in the vehicle width direction.

2. The battery pack according to claim 1, wherein:
a load receiving portion is provided on an outer side, in the vehicle width direction, with respect to the upper floor member, the load receiving portion being contacted by the upper floor member displaced toward the one side in the vehicle width direction; and
a second deformation starting point portion is provided at an intermediate portion, in the vehicle up-down direction, of the support member between the first deformation starting point portion and the upper floor member, the second deformation starting point portion serving as a deformation starting point at which deformation starts when the support member falls toward another side in the vehicle width direction after contacting the load receiving portion.

3. The battery pack according to claim 2, wherein:
a plurality of battery modules is coupled in the vehicle up-down direction in a state of being stacked in the vehicle up-down direction; and
a position, in the vehicle up-down direction, of the second deformation starting point portion is set to the same position as a position, in the vehicle up-down direction, of a coupling portion between one of the battery modules and a different one of the battery modules.

4. The battery pack according to claim 2, wherein
a third deformation starting point portion is provided on a side of a portion of the support member that is fixed to the upper floor member, the third deformation starting point portion serving as a deformation starting point at which deformation starts after the upper floor member contacts the load receiving portion.

5. The battery pack according to claim 1, wherein:
the battery cells are all-solid-state batteries and are disposed in a state of being arranged in a vehicle front-rear direction;
an end plate is fixed to each of an end portion, on a vehicle front side, and an end portion, on a vehicle rear side, of the battery module; and
the end plate is fixed to each of the lower floor member and the upper floor member.
